(19) United States
(12) Patent Application Publication
(10) Pub. No.: US 2008/0089715 A1
(43) Pub. Date: Apr. 17, 2008

(54) Image Forming Component

(76) Inventor: Gary Allen Denton, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/549,999

(22) Filed: Oct. 17, 2006

(51) Int. Cl. G03G 15/02; G03G 15/08; G03G 21/00

(52) U.S. Cl. 399/176; 399/286; 399/357

(57) ABSTRACT

A component for an image forming apparatus may include a seamless knit fabric which may be applied to a shaft. Both the fabric and the shaft may be electrically conductive. The fabric and the shaft may be separated by foam. The component may be employed in an image forming apparatus or in an image forming device cartridge.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present disclosure relates to a component for use in an image forming apparatus, or a cartridge for an image forming apparatus, wherein the component may include a seamless knitted pile fabric. For example, the present disclosure relates to the use of a seamless tubular knitted pile fabric that may be applied to a relatively cylindrical component which may be used in an image forming apparatus or cartridge.

2. Description of the Related Art

Image forming apparatus, such as printers, copiers, taxes, all-in-one devices or multifunctional devices, may include a number of cylindrical components that may be used as toner adder rolls or brushes, charging rolls or cleaning rolls. These components may be provided individually, provided within the image forming apparatus or provided within cartridges that may be used in conjunction with an image forming apparatus. Exemplary components may be electrically biased and used to convey toner to the photoconductive element in the image forming apparatus, clean various elements in the image forming apparatus or charge various elements in the image forming apparatus.

### SUMMARY OF THE INVENTION

The present disclosure relates to a component for an image forming apparatus. The component may include a shaft having a surface. A seamless knitted fabric having internal and external woven surfaces defining an internal volume may be engaged with the shaft wherein the internal surface of the seamless fabric surrounds and covers all or a portion of the shaft surface. The seamless fabric may also be conductive. A foam layer may be provided between the seamless fabric and the shaft. In one exemplary application the component may be employed to supply and charge toner within a photoconductive image forming device such as a laser printer.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of an exemplary embodiment of an image forming device component.

FIG. 2 is a cross-sectional view of the component of FIG. 1.

FIG. 2A is a cross-sectional view of the exemplary tubular seamless fabric

FIG. 3 is cross-sectional view of a fiber suitable for use to form a seamless fabric containing conductive additives in a surface layer.

FIG. 4 is cross-sectional view of another exemplary embodiment of an image forming device component; and

FIG. 5 is a cross-sectional view of another exemplary embodiment of an image forming device component.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The present invention relates to a component for use in an image forming device, which may include, for example, printers, copiers, fax devices, all-in-one devices or multifunctional devices. The component may be supplied individually, supplied within an image forming apparatus or supplied within a cartridge that may be used in conjunction with an image forming apparatus. One example of a cartridge would include a toner cartridge for an electrophotographic printer. The component may be of any geometry (e.g., it may be generally cylindrical) and may be an electrically biased component, such as a toner adder roll, a developer roller, a charging roll or a cleaning roll, all of which may be used with a photoconductive element. For example, in the case of an electrophotographic printer containing a photoconductive surface for forming a latent electrostatic image (e.g. a photoconductive drum), the component herein may be in the form of a toner adder roller that may charge and supply toner to a developer roller which may then deliver toner to the photoconductive surface for subsequent image development.

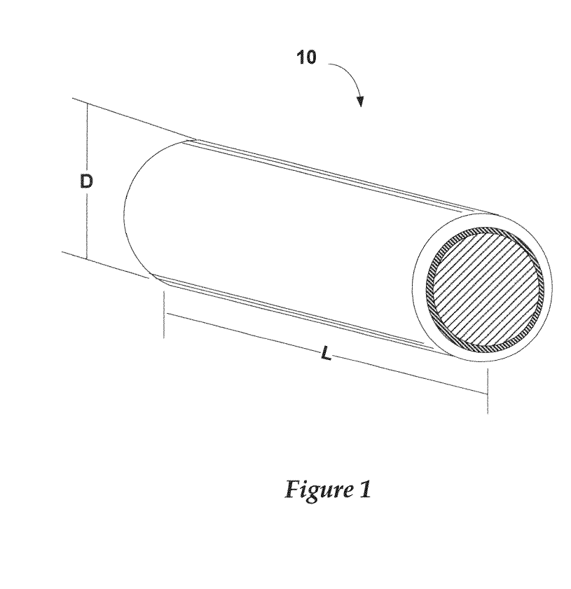

As illustrated in FIG. 1, an exemplary embodiment may include a component 10, having a length (L), and a diameter (D) and which may assume the general configuration of a roller. The length and diameter may vary depending on the desired application of the roller within a given image forming device. For example, the roller may be in the range of 10 and 500 mm in length including all values and increments therein.

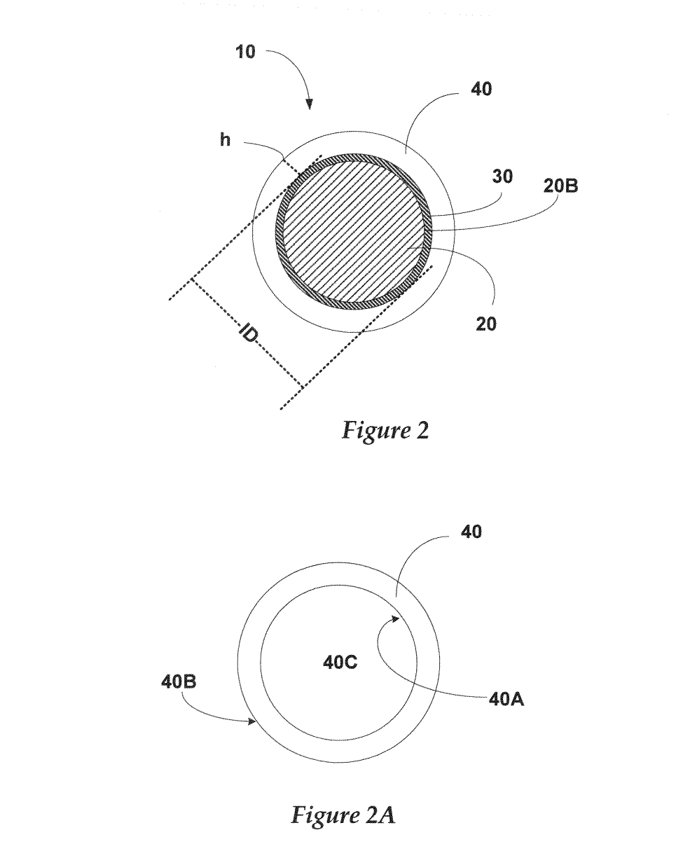

FIG. 2 illustrates a cross-sectional view of exemplary component 10. The component may include a shaft 20 having a surface, an adhesive 30 and a seamless fabric 40 having an internal surface 40A and external surface 40B (see FIG. 2A). A shaft may therefore be understood herein as any feature which may serve to provide support for the fabric 40. In addition, the internal surface 40A of the fabric may disposed over all or a portion of the surface 20B of the shaft 20. The shaft 20 may also be constructed in part or entirely from any conductive type material or any material that may include a conductive layer. For example, the conductive material may include a conductive metal or a polymeric material including a conductive material layer. The conductive metal may include steel or aluminum, which may be anodized and/or sealed.

The adhesive 30 may be used to adhere the fabric to the shaft and may be formulated from a pressure or a thermally activated adhesive. In addition, the adhesive may be conductive and therefore capable of transmitting a charge between the shaft 20 and the fabric 40. The conductive adhesive herein may therefore include an electrically conductive polymer system such as an ion-polymer type combination (e.g. a salt dispersed in a solid polymer resin). It can be appreciated that the ionic additives may broadly contemplate any organic or inorganic additive which provides an ionic charge or some form of electron transfer to facilitate conductivity within a host polymer. The conductive adhesive may also include a suitable polymeric binder. The conductive additive may include, for example, carbon black. The adhesive may also include a film that may be conductive, having adhesive applied thereon. The adhesive 30 may therefore be applied to the component via a number of methods such as dip coating, spray coating, etc., or the adhesive may be applied by the application of the film to the component.

The fabric 40 may be formed from fibers. The fibers may be formed into cut fibers, yarn, filaments or other elements. The fabric may be produced by intermeshing loops of the yarns, fibers, filaments, etc., to form a seamless tubular knitted fabric. Exemplary processes for forming the seamless tubular knit fabric may include circular knitting which may also be identified as knitting in the round. Accordingly, a seamless knitted fabric may be understood herein to include a fabric that may be formed in the general shape of a tube, although other geometries are contemplated. The feature of being seamless is reference to the fact that the fabric itself, as it extends along its length and surrounds a given surface, does not include a region where fabric is joined together. For example, joining together of the fabric by sewing, melt bonding, adhesive bonding, etc. along the length of the fabric is avoided. However it should be appreciated that the fabric may be modified at the ends to prevent fraying. In such a manner, the fabric may have an inner diameter (ID) of in the range of about 3 mm to about 50 mm, including all values and increments therein, such as 6 mm to 8 mm, 10 mm, etc. The fabric length may be in the range of about 10 mm to about 500 mm, including all values and increments therebetween. Accordingly, it may also be understood herein that the seamless fabric is one in which the fabric may have continuous inner 40A and outer 40B woven surfaces (see again, FIG. 2A) defining an interior volume 40C.

The loops of the fabric may form a pile which may be understood as a fabric surface containing either loops or free ends that may stand generally erect from a foundation surface. The pile may have a height (h) in the range of about 0.1 mm to about 20 nm, including all values and increments therein, such as between 3-6 mm, 0.5 mm to 2 mm, etc. In addition, the pile may be sheared to form cut fibers, having a depth in the range of about 0.5 to about 19 mm, including all values and increments therebetween, such as 3-6 mm, 0.5 mm to 2 mm etc. It should also be appreciated that the pile may include a combination of cut fibers and loops or may include loops or cut fibers of various heights on a single component. In an exemplary embodiment, the fabric may therefore include relatively smaller diameter fibers when utilizing a relatively short pile height. In another exemplary embodiment, the fabric may include relatively large diameter fibers when utilizing a relatively large pile height. Furthermore, depending upon the application, various pile height and diameter fibers may be utilized on a single component. Accordingly, it should be appreciated that variations of pile height and fiber diameter are contemplated herein as applied to a seamless and tubular knitted fabric construction.

The yarns, fibers, filaments, etc., may be formed from a polymeric material, such as an aliphatic polyamide (including nylon-6, nylon-6,6, etc.,) polyester (including PET), acrylics, cellulosics, natural fibers, combinations of various fibers, etc. The fibers may also be mono-, bi- or multi-component fibers. Fibers including more than one component may take on a sheath core configuration, side by side configuration, or various other configurations. In addition, the fibers themselves may be conductive and may include conductive additives such as carbon particles or copper sulfide compounds as well as other ionic additives. The conductive additives may be incorporated into the fibers as an additive or as a component of a bi- or multi-component fiber. In a further exemplary embodiment, the fibers may be initially non-conductive and treated before, during or after knitting to make the fibers conductive. For example, the fibers may be chemically modified or metallized with a conductive metal or metallic alloy, such as Ag, Ni, Cu, copper sulfide compounds, etc., to provide conductive fibers.

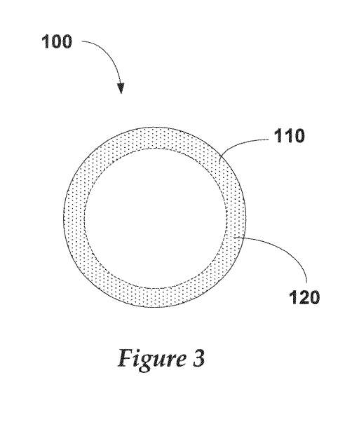

The fibers may have a diameter in the range of 5 μm to 80 μm, including all values and increments therein. In an exemplary embodiment, as illustrated in FIG. 3, the conductive additives 110 may be located within the surface layer 120 (illustrated in phantom) of the fiber, i.e. the additives may be located within 25 μms from the surface, including all values and increments therein, such as 5 μm, 1 μm, etc. The fibers may have a resistivity in the range of 10⁻² to 10⁹ Ω-cm including all values and increments therein. The denier of the fibers may be in the range of about 1 to about 100 including all values and increments therein. Exemplary fibers may be obtained from Shakespeare Conductive Fibers, LLC of Columbia, S.C., under the tradename Resistat®, Kanebo of Japan under the tradename Belltron, or Nihon Sanmo Dyeing Co. Ltd. of Japan under the tradename Thunderon®. The fabric 40 may be applied to the component by slipping the fabric over the shaft.

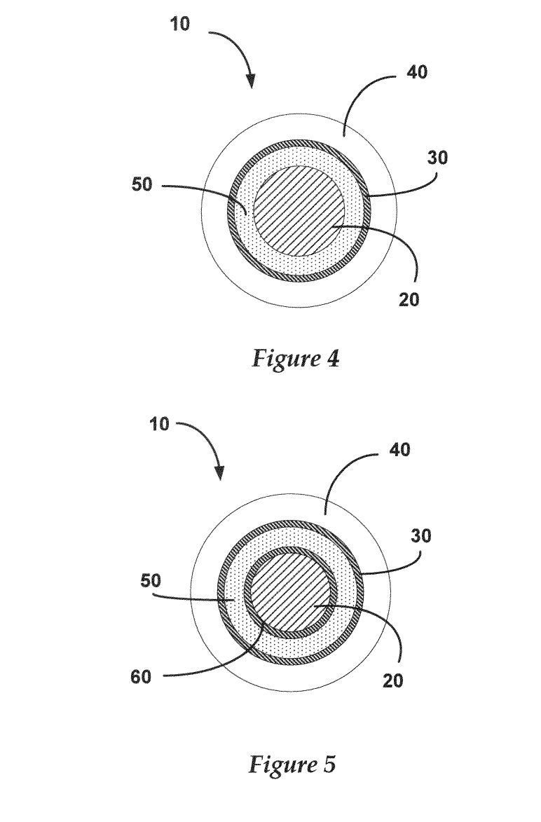

Illustrated in FIG. 4 is another exemplary embodiment that may include foam 50 in the component 10. The foam may be conductive and may therefore include conductive additives intermixed within the foam or a conductive layer formed on or within the foam surface. The foam may also be open cell, closed cell or reticulated. The foam may include a polymeric material, including urethane, silicone, or a thermoplastic such as a polyolefin. The foam herein may have a density of between about 2-10 lbs/ft³, including all values and increments therein and a compression force deflection of 0.5-3 PSI at 25% compression, including all values and increments therein. The foam may have a resistivity in the range of 10⁻² to 10⁹ Ohm-cm. The seamless tubular fabric 40 may be slipped over the foam 50. Disposed in between the foam and the fabric may be an adhesive 30 which may be a conductive adhesive.

In addition, and as illustrated in FIG. 5, a second adhesive 60 may be applied between the shaft 20 and the foam 50. The second adhesive may also be a pressure or thermally activated adhesive and may include the same or another base polymer material. In addition, the second adhesive may contain relatively more or relatively less conductive additives depending upon the application of the component.

Accordingly, it should be understood herein that a tubular and seamless knit fabric, and in particular a conductive fabric, may be applied to a shaft to form a conductive component for use within an image forming apparatus. Such seamless type construction may therefore provide at least one beneficial feature when compared to the use of, e.g., conventional type “seamed” construction. For example, in the case of a conventional image forming device charging component, formed by weaving a pile fabric and wrapping around a shaft, it may be appreciated that the pile density at or near the seams is reduced or interrupted with respect to its continuity across the shaft surface, thereby promoting the formation of image artifacts which may be due to non-uniform charging. Therefore, in a performance context, the relatively seamless knit fabric herein may be understood as a fabric, that when employed on a conductive component within an image forming device, offers relatively uniform pile density and/or the lack of regions wherein there may be a discontinuity in the pile density across the roller surface. In addition, the seamless construction herein may also provide relatively uniform charging characteristics.

The components herein for use within an image forming apparatus may be manufactured by fitting the fabric over a shaft wherein the fabric may be releasably engaged to the shaft. However, in a further exemplary embodiment, and as alluded to above, an adhesive may be disposed onto the shaft to more permanently adhere the fabric to the shaft, which may therefore be more desirable with respect to a given printer component requirement.

Similarly, as noted above, the tubular knit fabric may be applied to a shaft over a layer of foam. The foam layer may be applied to the shaft by a number of methods, such a slipping a foam roll over a shaft or wrapping the foam layer over the shaft. The fabric may then be slipped over the foam layer. It is also contemplated that the fabric may be applied over the foam prior to applying the foam layer to the shaft. Optionally an adhesive may be provided between the foam and the shaft and/or a second adhesive may be applied between the foam layer and the fabric.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A component for an image forming apparatus comprising a shaft having a surface and a seamless knitted fabric having internal and external surfaces defining an internal volume wherein said internal surface of said seamless fabric surrounds and covers all or a portion of said shaft surface.

2. The component of claim 1 wherein said fabric comprises conductive fibers.

3. The component of claim 2 wherein said conductive fibers have a resistivity in the range of 10⁻² to 10⁹ Ω-cm.

4. The component of claim 1 wherein said fabric comprises a polymeric material selected from the group comprising polyamide, polyester, cellulosics, acrylics, natural fibers or combinations thereof.

5. The component of claim 1 further comprising a conductive adhesive disposed between said shaft and said knitted fabric.

6. The component of claim 1 further comprising a foam disposed between said fabric and said shaft.

7. The component of claim 1 wherein said fabric comprises pile and said pile includes loops, cut fibers or a combination thereof.

8. The component of claim 1 located within an image forming device.

9. The component of claim 1 located within an image forming device cartridge.

10. An electrophotographic printing assembly comprising
a photoconductive element;
a developer roller for supplying toner to said photoconductive element;
a toner adder roller for supplying toner to said developer roller, wherein said toner adder roller or developer roller includes a shaft having a surface and a seamless knitted fabric having internal and external surfaces defining an internal volume wherein said internal surface of said seamless fabric surrounds and covers all or a portion of said shaft surface.

11. The assembly of claim 9 wherein said fabric comprises conductive fibers.

12. The assembly of claim 10 wherein said conductive fibers have a resistivity in the range of 10⁻² to 10⁹ Ω-cm.

13. The assembly of claim 9 wherein said fabric comprises a polymeric material selected from the group comprising polyamide, polyester, cellulosics, acrylics, natural fibers or combinations thereof.

14. The assembly of claim 9 further comprising a conductive adhesive disposed between said shaft and said tubular knitted fabric.

15. The assembly of claim 9 further comprising a foam disposed between said fabric and said shaft.

16. The assembly of claim 9 wherein said fabric comprises pile and said pile includes loops, cut fibers or a combination thereof.

17. An electrophotographic printing assembly comprising
a photoconductive element;
a charging roller for supplying a charge to said photoconductive element, wherein said charging roller includes a shaft having a surface and a seamless knitted fabric having internal and external surfaces defining an internal volume wherein said internal surface of said seamless fabric surrounds and covers all or a portion of said shaft surface.

18. The assembly of claim 16 wherein said fabric comprises conductive fibers.

19. The assembly of claim 17 wherein said conductive fibers have a resistivity in the range of 10⁻² to 10⁹ Ω-cm.

20. The assembly of claim 16 wherein said fabric comprises a polymeric material selected from the group comprising polyamide, polyester, cellulosics, acrylics, natural fibers or combinations thereof.

21. The assembly of claim 16 further comprising a conductive adhesive disposed between said shaft and said tubular knitted fabric.

22. The assembly of claim 16 further comprising a foam disposed between said fabric and said shaft.

23. The assembly of claim 16 wherein said fabric comprises pile and said pile includes loops, cut fibers or a combination thereof.

24. An electrophotographic printing assembly comprising
a photoconductive element;
a cleaning roller for removing toner from said photoconductive element, wherein said cleaning roller includes a shaft having a surface and a seamless knitted fabric having internal and external surfaces defining an internal volume wherein said internal surface of said seamless fabric surrounds and covers all or a portion of said shaft surface.

25. The assembly of claim 23 wherein said fabric comprises conductive fibers.

26. The assembly of claim 24 wherein said conductive fibers have a resistivity in the range of 10⁻² to 10⁹ Ω-cm.

27. The assembly of claim 24 wherein said fabric comprises a polymeric material selected from the group comprising polyamide, polyester, cellulosics, acrylics, natural fibers or combinations thereof.

28. The assembly of claim 24 further comprising a conductive adhesive disposed between said shaft and said tubular knitted fabric.

29. The assembly of claim 24 further comprising a foam disposed between said fabric and said shaft.

30. The assembly of claim 24 wherein said fabric comprises pile and said pile includes loops, cut fibers or a combination thereof.
